(19) United States
(12) Patent Application Publication
(10) Pub. No.: US 2011/0010025 A1
(43) Pub. Date: Jan. 13, 2011

(54) MONITORING SYSTEM USING UNMANNED AIR VEHICLE WITH WIMAX COMMUNICATION

(75) Inventors: Jai Hong Eu, Seoul (KR); Jin Seok Heo, Gyeongsangbuk-do (KR)

Correspondence Address: RABIN & Berdo, PC, 1101 14TH STREET, NW, SUITE 500, WASHINGTON, DC, 20005, US

(73) Assignee: JCAST Networks Korea, Inc., Gyeonggi-do (KR)

(21) Appl. No.: 12/921,138

(22) PCT Filed: Jun. 25, 2008
(86) PCT No.: PCT/KR08/03642

§ 371 Date: Sep. 3, 2010

(30) Foreign Application Priority Data
Mar. 10, 2008 (KR) 10-2008-0022162

(51) Int. Cl. G05D 1/00

(52) U.S. Cl. 701/2

(57) ABSTRACT

Provided is a monitoring system using an unmanned air vehicle communicated based on a WiMAX communication scheme. The monitoring system includes an air vehicle and a relay unit. The air vehicle includes a photographing unit for capturing on-scene image information of a current flying area, and a global positioning system (GPS) receiver for receiving GPS information of the current flying area. The air vehicle transmits the on-scene image information and the GPS information, wirelessly. The relay unit remotely controls the air vehicle by receiving a travel command signal having information on a destination of the air vehicle, wirelessly transmits the travel command signal to the air vehicle based on the WiMAX communication scheme, and wirelessly receives the on-scene image information and the GPS information from the air vehicle based on the WiMAX communication scheme.

### TECHNICAL FIELD

The present invention relates to a monitoring system using an unmanned air vehicle with WiMAX communication and, more particularly, to a monitoring system using an unmanned air vehicle with WiMAX communication for monitoring a target area using camera image information that is transmitted in real time from an unmanned air vehicle.

### BACKGROUND ART

As a method for monitoring an area from a remote location according to the related art, a stationary camera is disposed at a predetermined location and controlled in left and right, and up and down directions to monitor the area.

According to the monitoring method according to the related art, the monitoring area is restrictive and it is impossible to capture images of a wide area because a camera captures images of an only area limited by the installation location of the camera.

In order to overcome such a shortcoming, an area is divided into a plurality of sections and a plurality of cameras are disposed at each of the sections. The sections are compared and monitored using the corresponding cameras.

Such a monitoring method using the plurality of cameras has shortcomings of a high installation cost and a maintenance difficulty. Particularly, if a target monitoring area is very wide such as mountains, seashore, valley, and a military area, it is almost impossible to use this method due to the number of cameras required.

Also, many routes are needed to transmit captured image data from the plurality of cameras to a control center at a remote location. In case of using cables to transmit the captured image data, it is very difficult to install the cables due to the wide monitoring area. Also, it requires a high installation cost. In case of using a wireless route such as radio frequency (RF), it is difficult to transmit the large amount of data and to maintain the wireless routes because the number of wireless routes increases corresponding to the number of cameras. Also, the number of allocated channels is limited, and a transmission distance and a transmit rate are limited.

Meanwhile, various disasters, such as flood, fire, damages by blight and harmful insects, and detection of a vehicle in a vehicle restricted area, may be happened in mountains, seashore, a military area, and a vehicle restricted area. Some of them may require an emergency rescue operation.

Conventionally, a disaster prevention center dispatches a helicopter to a disaster area, and a pilot of the helicopter or rescuer reports situations of the disaster area by words of mouth using a communication device such as a mobile phone.

However, there was a limitation to instantly and accurately report information on the disaster area and the current state thereof by words of mouth using the communication device. Accordingly, a national emergency management agency could not easily analyze the current state of the disaster location and had difficulties to immediately perform a follow-up operation such as sending out rescuers. Finally, the damages of the disaster area were accumulated.

The national emergency management agency of Korea only has one helicopter, and if the national emergency management agency wants to dispatch the helicopter, the national emergency management agency must be approved by the national police agency and the defense ministry after sending related archives to them. Since the process of dispatching the helicopter is so complicated and time consuming process, it is very difficult to effectively deal with the disasters.

### DISCLOSURE OF INVENTION

### Technical Problem

An embodiment of the present invention is directed to a monitoring system using an air vehicle with WiMAX communication, which enables real-time tracking and monitoring of images captured by the air vehicle and corresponding location information thereof per a unit time by capturing on-scene image information of a target monitoring area and obtaining corresponding GPS information thereof using the air vehicle having a photographing unit and a GPS receiver and transmitting the on-scene image information and the GPS information to a relay unit at a remote location in real time using a WiMAX communication scheme, and improves a wireless environment by securing enough wireless transmission period.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### TECHNICAL SOLUTION

In accordance with an aspect of the present invention, there is provided a monitoring system using an air vehicle communicated based on a worldwide interoperability for microwave access (WiMAX) communication scheme, including: an air vehicle including a photographing unit for capturing on-scene image information of a current flying area, and a global positioning system (GPS) receiver for receiving GPS information of the current flying area wherein the air vehicle transmits the on-scene image information and the GPS information, wirelessly; and a relay unit for remotely controlling the air vehicle by receiving a travel command signal having information on a destination of the air vehicle, wirelessly transmitting the travel command signal to the air vehicle based on the WiMAX communication scheme, and wirelessly receiving the on-scene image information and the GPS information from the air vehicle based on the WiMAX communication scheme.

The air vehicle may use an omni antenna to wirelessly transmit and receive information based on the WiMAX communication scheme, and the relay unit may use a directional antenna to wirelessly transmit and receive information based on the WiMAX communication scheme.

The relay unit may further include a pan tilting module for performing a pan tilting operation to control a direction of the directional antenna in real time using variation of GPS information of the air vehicle per a unit time, which is comparatively changed based on current location information of the relay unit.

The pan tilting module may control a direction of the directional antenna in real time using a pan angle variation

(Δθ=θ−θ′)

and a tilt angle variation

(Δφ=φ−φ′),

which are calculated based on a difference

(ΔP=P−P′)

between a before-flight coordinate P of the air vehicle before making flight and an after-flight coordinate P after making flight based on a coordinate O of the relay unit, and in case of the before-flight coordinate P of the air vehicle 110 before making flight, a pan angel and a tilt angle are defined as:

$$\begin{matrix}\begin{matrix}θ = {cos}^{- 1} ( \frac{z}{r} ) , \\ r = \sqrt{{x}^{2} + {y}^{2} + {z}^{2}}\end{matrix} \\ ϕ = {cos}^{- 1} ( \frac{x}{\sqrt{{x}^{2} + {y}^{2}}} )\end{matrix}$$

wherein r denotes a distance from the coordinate O of the relay unit to the before-flight coordinate P of the air vehicle before making flight, and x, y, and z denote a x-axis coordinate (longitude), a y-axis coordinate (latitude), and z-axis coordinate (altitude) of the before-flight coordinate P of the air vehicle before making flight based on the coordinate O of the relay unit.

The relay unit may be a vehicle and further include a GPS module receiving vehicle GPS information which is current location information of the vehicle, and the pan tilting module may control a direction of the directional antenna in real time using variation of the GPS information value of the air vehicle per a unit time, which is comparatively changed based on the vehicle GPS information that is the current location information of the vehicle.

The relay unit may perform an pan tilting operation when receive sensitivity of the on-scene image information and the GPS information transmitted from the air vehicle is dropped below a predetermined level.

The relay unit may further include an additional relay unit for transmitting the received on-scene image information and the GPS information to an external disaster prevention center and for wirelessly relaying information between the relay unit and the external disaster prevention center based on the WiMAX communication scheme.

The relay unit may further include a display unit for displaying the on-scene information and the GPS information corresponding to the on-scene information from the air vehicle with a map linked.

### ADVANTAGEOUS EFFECTS

A monitoring system using an air vehicle with WiMAX communication according to the present invention provide following effects.

At first, the monitoring system according to the present invention enables real-time and instant tracking and monitoring of images captured by the air vehicle and corresponding location information thereof per a unit time by capturing on-scene image information of a target monitoring area and obtaining corresponding GPS information thereof using the air vehicle having a photographing unit and a GPS receiver and transmitting the on-scene image information and the GPS information to a relay unit at a remote location in real time using a WiMAX communication scheme. The monitoring system according to the present invention also enables an instant countermeasure for a disaster by immediately dispatching emergency rescuers when a predetermined disaster is occurred in a corresponding area.

Secondly, the monitoring system according to the present invention secures enough wireless transmission period and supports high speed long distance transmission by using a WiMAX communication scheme. Particularly, the monitoring system according to the present invention can be vary useful if it is required to immediately transmit information in an urgent environment where needs an emergency rescue operation.

Thirdly, the monitoring system according to the present invention can advantageously maintains link between the relay unit and the air vehicle using a pan tilting module disposed at the relay unit.

Fourthly, the monitoring system according to the present invention can overcome obstacles of radio wave propagation paths and further expand a transmission period by including an additional relay unit between the air vehicle and the relay unit or between the relay unit and an external disaster prevention center.

### BRIEF DESCRIPTION OF THE DRAWINGS

FIG. 1 is a diagram illustrating a monitoring system using an unmanned air vehicle with WiMAX communication according to an embodiment of the present invention.

FIGS. 2 and 3 are diagrams illustrating a monitoring system of FIG. 1 with an additional relay unit according to another embodiment of the present invention.

FIG. 4 is a diagram illustrating operation of a monitoring system of FIG. 1 according to an embodiment of the present invention.

FIG. 5 is a diagram illustrating communication between an air vehicle and a relay unit of FIG. 1 according to an embodiment of the present invention.

FIG. 6 is a diagram illustrating an air vehicle of FIG. 1 according to an embodiment of the present invention.

FIG. 7 is a diagram illustrating a relay unit of FIG. 1 according to an embodiment of the present invention.

FIG. 8 is a diagram illustrating a pan tilting module of FIG. 1 according to an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. Terms and words used in specification and claims must not be understood as typical or dictionary meaning only. Terms and words may be understood as meanings and concepts corresponding to technical aspects of the present invention based on the principle that inventors may properly define concepts of terms in order to describe own invention with the best method.

Therefore, embodiments described in specification and configurations shown in accompanying drawings are only an embodiment of the present invention. Since the embodiments and the configurations may not represent all of technical aspects of the present invention, there may be various equivalents and modifications which can replace the embodiments and the configuration at a time of filing a related application.

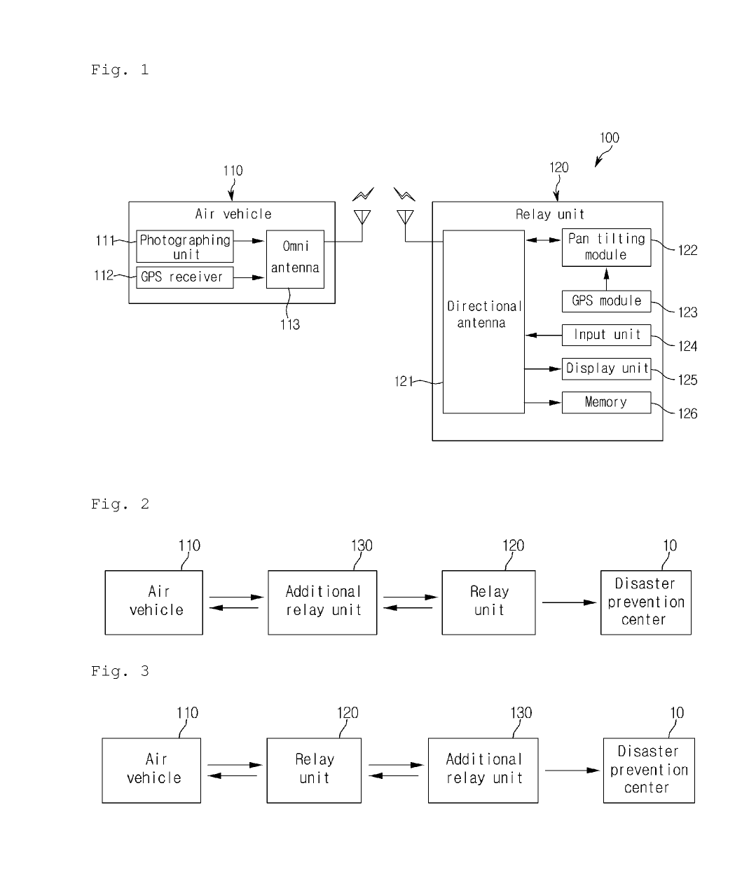

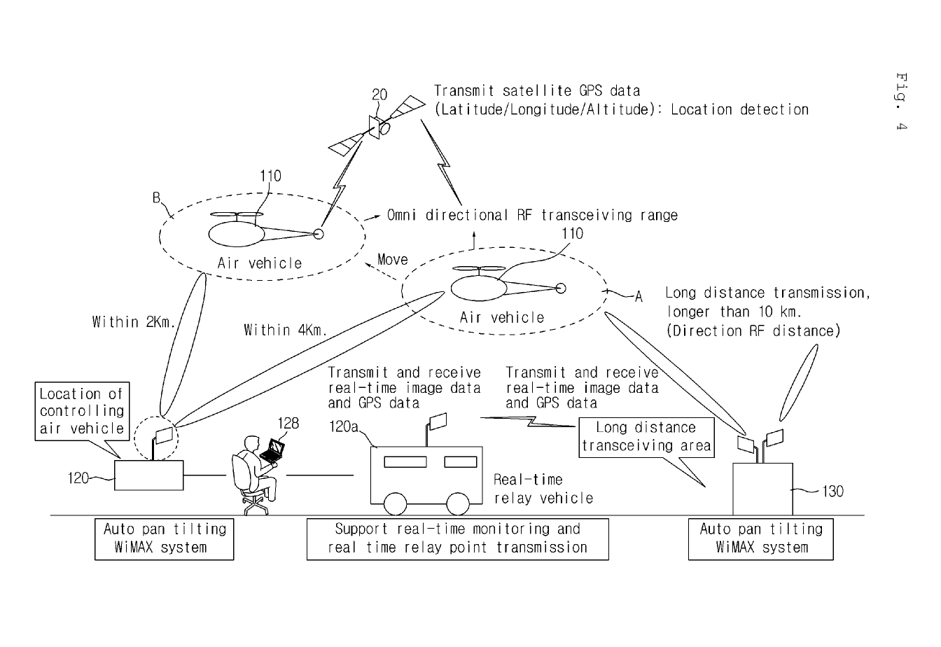

FIG. 1 is a diagram illustrating a monitoring system using an unmanned air vehicle with WiMAX communication according to an embodiment of the present invention, FIGS. 2 and 3 are diagrams illustrating a monitoring system of FIG. 1 with an additional relay unit according to another embodiment of the present invention, and FIG. 4 is a diagram illustrating operation of a monitoring system of FIG. 1 according to an embodiment of the present invention.

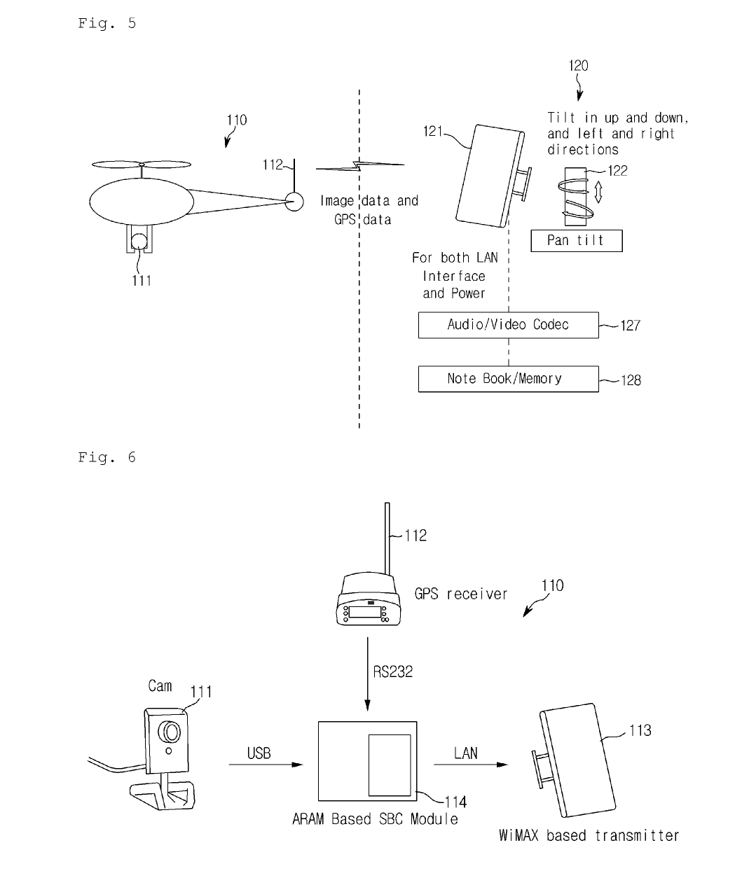

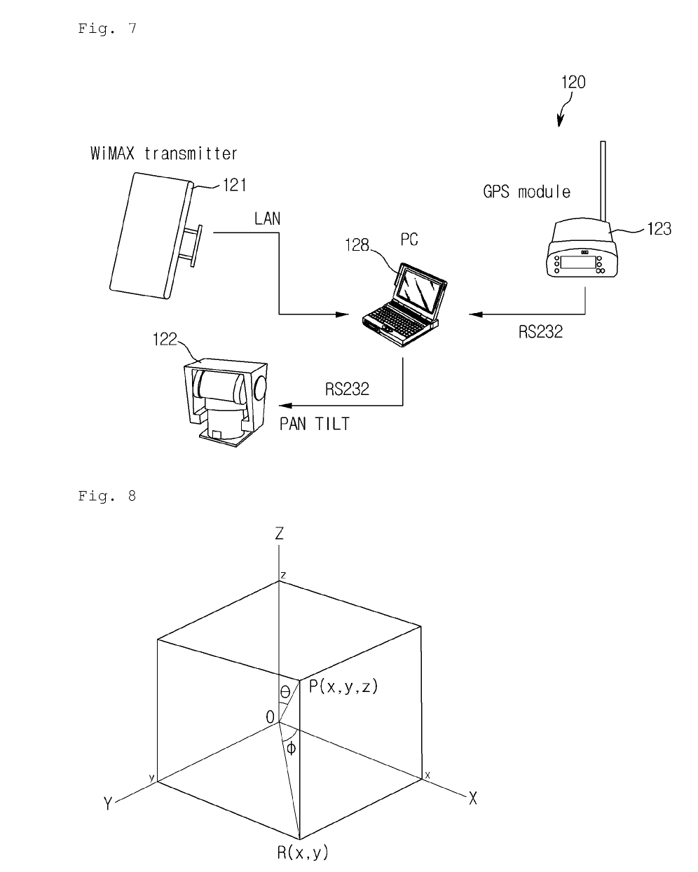

FIG. 5 is a diagram illustrating communication between an air vehicle and a relay unit of FIG. 1 according to an embodiment of the present invention, FIG. 6 is a diagram illustrating an air vehicle of FIG. 1 according to an embodiment of the present invention, and FIG. 7 is a diagram illustrating a relay unit of FIG. 1 according to an embodiment of the present invention. FIG. 8 is a diagram illustrating a pan tilting module of FIG. 1 according to an embodiment of the present invention.

As shown, the WiMAX based monitoring system 100 using an air vehicle according to the present embodiment includes an air vehicle 110 and a relay unit 120.

As shown in FIGS. 1, 5, and 6, the air vehicle 110 may be an air plane driven by a pilot or a pilotless air plane. The air vehicle 110 includes a photographing unit 111, a global positioning system (GPS) receiver 112, and an omni antenna 113.

The photographing unit 111 captures on-scene images which are images of a disaster area under a current flight route of the air vehicle.

The photographing unit 111 may be a typical camera or a high resolution camera that supports a resolution higher than 1024×768. The photographing unit 111 further includes a coder and decoder (CODEC) device (not shown) for coding and decoding images.

The photographing unit 111 may further include a camera gimbal (not shown) or a camera driving motor (not shown) for rotating the photographing unit 111 in up and down or left and right directions by an operator in a location of the relay unit 120 in order to effectively secure a visual field.

The GPS receiver 112 receives GPS information of the current in-flight area from a satellite 20 shown in FIG. 4. The GPS information includes information on latitude, longitude, and altitude of the current in-flight area.

Here, a circuit board 114 of FIG. 6 may control operations of the photographing unit 111 and the GPS receiver 112 and process information received from the photographing unit 111 and the GPS receiver 112.

The air vehicle 110 may wirelessly transmit the on-scene image information from the photographing unit 111 and the GPS information from the GPS receiver 112 to the relay unit 120 based on a worldwide interoperability for microwave access (WiMAX) communication scheme. For example, a 3 dB antenna may be used.

The air vehicle 110 may use an omni antenna to wirelessly communicate with the relay unit based on the WiMAX communication scheme. The omni antenna 113 can advantageously enable the air vehicle 110 to uniformly transmit and receive information in onmidirections in regardless of movements of the air vehicle 110.

The monitoring system 100 according to the present embodiment can transmit the on-scene image information of a target monitor area and the GPS information related thereto to the relay unit 120 at a remote location in real-time based on the WiMAX communication scheme using the air vehicle 110 having the photographing unit 111 and the GPS receiver 112.

While the air vehicle 110 is making a flight to a predetermined area by a travel command from the relay unit 120, the air vehicle 110 may synchronize on-scene image information of the photographing unit 120 and the GPS information from the GPS receiver 112 by time slots and transmits the synchronized information to the relay unit 120.

The relay unit 120 analyzes the on-scene images such as moving images and corresponding GPS information from the air vehicle 110 and monitors the states of the disaster area based on the analyzing result in real time.

Although the on-scene image information and the GPS information are transmitted based on the WiMAX communication scheme in the present embodiment, a communication scheme may be changed. For example, the on-scene information may be transmitted and received through a WiMAX communication path and the GPS information may be transmitted using a wider bandwidth such as VHF (72 MHz) or UHF because the GPS information may not be transmitted or received according to a photographing area due to the limitation of the visual sight according to a photographing area

The relay unit 120 includes a directional antenna 121, an input unit 124, a display unit 125, and a memory 126 as shown FIG. 1.

The input unit 124 receives a travel command signal which is a signal related to a destination of the air vehicle. For example, an operator at the relay unit 120 can input such a travel command signal using a keyboard, a mouse, and a touch screen as the input unit 124.

The display unit 125 visually displays a map related to a target flight destination, a graphic, and a list related to the target flight destination, in order to enable the operator to conveniently operate the air vehicle through the input unit 124.

The input unit 124, the display unit 125, and the memory 126 may be replaced with a personal computer 128 shown in FIG. 4 or FIG. 7. The relay unit 120 may include a wired network (not shown) in case of the relay unit 120 is a fixed station such as a building. In this case, the relay unit 120 may transfer the received information through an IP network to analyze the received information.

The relay unit 120 may further include an audio/video CODEC 127 for processing the on-scene image information as shown in FIG. 5.

The relay unit 120 receives the travel command signal received from the input unit 124 and wirelessly transmits the received travel command signal using the directional antenna 121, thereby remotely controlling the air vehicle 110.

The air vehicle 110 may automatically fly to a destination by real time comparing destination information included in the travel command signal with the GPS information of a current in-flight area received from the GPS receiver 112.

The relay unit 120 receives destination information from a user using a personal computer at a remote location and wirelessly transmits the received destination information to the air vehicle 110. Then, the air vehicle 110 flies to a target coordinate based on the destination information, captures on-scene images of a target area through the photographing unit 111, and transmits the captured on-scene images to the relay unit 120 in real time.

As described above, the directional antenna 121 of the relay unit 120 is used to wireless communicate with the air vehicle 110 through the WiMAX communication scheme. For example, the directional antenna 121 of the relay unit 120 may be a 17 dB antenna or a 20 dB antenna. Since the directional antenna 121 is directional, it is possible to transmit and receive data within a predetermined angle range and it may be changed according to an antenna pattern design.

Here, it is preferable to use a directional antenna for long distance transmission instead of using the omnidirection antenna.

Meanwhile, the relay unit 120 wirelessly receives the on-scene image information and the GPS information from the air vehicle 110 through the directional antenna 121 in real time based on the WiMAX communication scheme. The received information is stored in the memory 126 and may be managed and searched. The display unit 125 may display the received information in real time.

For example, the display unit 125 displays the on-scene image information from the air vehicle 110 and the GPS information corresponding to the on-scene image information with a two dimensional (2D) map or a three dimensional (3D) map. That is, the display unit 125 enables operators to conveniently and visually analyze the on-scene image of the disaster area to detect an exact disaster area and related details.

Each section of the map displayed on the display unit 125 has a GPS coordinate value. It is possible to display not only a predetermined section matched with a coordinate value in the GPS information but also peripheral areas around the section thereof by comparing the GPS coordinate value with the GPS information received from the air vehicle 110.

As described above, the relay unit 120 can monitor target areas in real time using the on-scene image information and the GPS information. If a disaster is occurred in the target area, it is possible to detect a current disaster state and a location of the disaster in real time based on the captured on-scene image information and the obtained GPS information from the air vehicle 110. It is also possible to immediately cope with the situation of the disaster such as dispatching rescuers based on the detecting result.

Here, the on-scene corresponding to the destination information may be a mountain, seashore, a valley, a military area, and a vehicle restricted area, and the disaster may be fire, flood, damages by blight and harmful insects, detection of a vehicle in a vehicle restricted area, and wars.

That is, the monitoring system according to the present embodiment can be used to monitor forest fire in mountains, to monitor an enemy s base, to inspect the damage of pine trees, to survey the damage of a tidal wave, to research high and low tide, to monitor the vehicle restricted area, and to survey environmental assessment.

Meanwhile, the monitoring system according to the present embodiment adapts the WiMAX technology (IEEE 802.16d) which is a communication technology supporting a high speed wireless multimedia communication service using a 5.8 GHz bandwidth. Since the WiMAX technology expands a communication service to a broadband network by breaking from a short range wireless communication scheme, the WiMAX technology can effectively links wired and wireless communication networks and provide dynamic services.

Such a WiMAX technology supports long distance transmission up to maximum of 120 km and a transmit rate of 40 Mbps maximally. Therefore, the WiMAX technology has an advantage of high speed long distance transmission in a view that the WiMAX technology can transmit a mass amount of various data such as sensor data including audio and image data at once. Particularly, the WiMAX technology can be advantageously used if it is required to instantly transmit information in an urgent situation such as a rescuing operation.

Meanwhile, the relay unit 120 according to the present embodiment can transmit the on-scene image information and the GPS information received from the air vehicle 110 to an external disaster prevention center 10 through wired transmission or through wireless transmission.

Here, in case of the wireless transmission, the relay unit 120 may further include an additional antenna (not shown) supporting the WiMAX communication scheme in order to transmit information from the relay unit 120 to the external disaster prevention center 10 because the external disaster prevention center 10 is located in a different direction from the air vehicle 110.

In case of the wired transmission, the relay unit 120 may transmit information through an additional wired network such as the Internet.

The disaster prevention center 10 may be fire defense headquarter, a fire station, a police station, a regional government office, and the department of defense. The disaster prevention center 10 can properly distribute emergency rescuers by receiving the on-scene image information and the GPS information, storing the received information, and the analyzing the stored information.

The disaster prevention center 10 can generate various statistics such as a current disaster occurrence state based on the on-scene image information and the corresponding GPS information and stores the generated statistics as a database of related monitoring areas. Such a database can be usefully used to consider measures and national policies for disasters.

Although a wireless transmission distance of the WiMAX communication scheme is about 40 km to 60 km in a mobile environment, receive sensitivity may be significantly dropped in substance due to obstacles of a radio wave propagation path, such as buildings, trees, and mountains.

In this case, an additional relay unit 130 for relaying information based on the WiMAX communication scheme is further included between the relay unit 120 and the air vehicle 110 or between the relay unit 120 and the external disaster prevention center 10 in order to further extend the transmission distance and significantly improve a wireless transmission environment. The monitoring system 100 according to the present embodiment may include more than one additional relay unit 130.

It is preferable to dispose the additional relay unit 130 at a hilly area where has less obstacles of radio wave propagation, for example, the Seoul tower, in order to further improve the relay effect.

Meanwhile, the relay unit 120 has a directional radio wave characteristic within a predetermined angel range of the directional antenna 121, and the air vehicle 110 has omnidirectional radio wave characteristic through the omni directional antenna 113 unlike the relay unit 120.

It is preferable that the relay unit 120 includes a pan tilting module 122 shown in FIGS. 1, 5, and 7 in order to constantly sustain communication with the air vehicle 110 that moves at all times while making flight.

For example, it is preferable to control a direction of the directional antenna 121 in the relay unit 120 using the pan tilting module 122 while the air vehicle 110 is traveling from a location A to a location B as shown in FIG. 4.

Here, the pan tilting module 122 can perform a pan-tiling operation to control the direction of the directional antenna 121 in real time using the variation of GPS information of the air vehicle 110 per a unit time, which is comparatively changed from the location of the relay unit 120.

If the relay unit 120 is a stationary type, for example, if the relay unit 120 is immovably disposed on the top of a building, the pan tilting module 122 calculates a difference value between previously stored GPS information of the building and the GPS information received from the air vehicle 110 through a trigonometric function, transforms the difference value to a gear ratio for gears (not shown) included in the pan tilting module 122, performs the pan-tilting operation based on the gear ratio.

The trigonometric function calculation or the transform of the gear ratio may be realized by the PC 128 of FIG. 7.

The pan tilting operation of the pan tilting module 122 will be described with reference to FIG. 8.

The pan tilting module 122 can control a direction of the directional antenna 121 in real time using a pan angle variation (

Δθ=θ−θ′

) and a tilt angle variation (

Δφ=φ−φ′

), which are calculated based on a difference (

ΔP=P−P′

) between a before-flight coordinate P of the air vehicle 110 before making flight and an after-flight coordinate P′ after making flight based on a coordinate O of the relay unit 120.

Referring to FIG. 8, the pan angle variation denotes an antenna angle variation of the directional antenna 121 in up and down directions, and the tilt angel variation denotes an antenna angle variation of the directional antenna 121 in left and right directions.

In case of the before-flight coordinate P of the air vehicle 110 before making flight, a pan angel O and a tilt angle wan be defined by Eq. 1 and Eq. 2 as follows.

$$\begin{matrix}\begin{matrix}θ = {cos}^{- 1} ( \frac{z}{r} ) , \\ r = \sqrt{{x}^{2} + {y}^{2} + {z}^{2}}\end{matrix} & Eq . 1 \\ ϕ = {cos}^{- 1} ( \frac{x}{\sqrt{{x}^{2} + {y}^{2}}} ) & Eq . 2\end{matrix}$$

In Eq. 1 and Eq. 2, r denotes a distance from the coordinate O of the relay unit 120 to the before-flight coordinate P of the air vehicle before making flight, and x, y, and z denote a x-axis coordinate (longitude), a y-axis coordinate (latitude), and z-axis coordinate (altitude) of the before-flight coordinate P of the air vehicle 100 before making flight based on the coordinate O of the relay unit 120.

After passing a predetermined time, the air vehicle 110 moves to the after-flight coordinate P′(not shown) from the before-flight coordinate P of FIG. 8. Here, x, y, and z , which are coordinate values received from the GPS receiver 112, may be changed to x′, y , and z′ Accordingly, the pan angle and the tilt angle are also changed to θ and φ

Therefore, the pan tilting operation may be performed by calculating the pan angle variation and the tilt angle variation, which are angles of the direction antenna 121 to be changed corresponding to the movement of the air vehicle 100, as described above.

If the relay unit 120 is a mobile type, for example, if the relay unit 120 is a vehicle 120a shown in FIG. 2, the relay unit 120 may further include a GPS module 123 for receiving vehicle GPS information that is a current location of the vehicle 120a as shown in FIG. 1 or FIG. 7.

The pan tilting module 122 can control the direction of the directional antenna 121 in real time using variation of the GPS information value of the air vehicle 110 per a unit time, which is comparatively changed based on the vehicle GPS information that is the current location information of the vehicle 120a.

In more detail, if the relay unit 120 is the vehicle 120a, the pan tilting module 122 analyzes latitude, longitude, and altitude included in the vehicle GPS information of the vehicle 120a and the GPS information from the air vehicle 110, calculates a difference value between the GPS information and the vehicle GPS information using a trigonometric function, and performs a pan tilting operation by controlling a gear ratio using the difference value.

That is, if the relay unit 120 is the vehicle 120a, the vehicle 120a can smoothly receive and monitor the on-scene image information and the GPS information from the air vehicle 110 while making flight and controls a rescue operation at a location near to a target monitoring area at the same time.

When the relay unit 120 determines that the receive sensitivity of the on-scene image information and the GPS information received from the air vehicle 110 is dropped below a predetermined level, the pan tilting operation can be performed using the pan tilting module 122.

Since the on-scene image information and the GPS information are important material to analyze a current target monitoring area, it is impossible to analyze the on-scene image information and the GPS information if these information are not properly received or if these information are received with a low receive sensitivity level and with noise. Therefore, it is prefer to perform the pan tilting operation, if the receive sensitivity is lower than a predetermined level.

For example, if it is determined that the receive sensitivity is dropped below a predetermined level when a time is changed from t0 to t1, the pan tilting module 122 may perform the pan tilting operation by calculating a difference value between location information of the relay unit 120 and the GPS information of the vehicle 110.

That is, the directional antenna 121 sustains an antenna angle of a time t0 without performing the pan tilting operation during a time period from t0 to t1 because the receive sensitivity is higher than a predetermined level during the time period from t0 to t1. When the receive sensitivity is dropped below the predetermined level at the time t1, the antenna angle is reset by the calculation and the pan tilting operation. Since the pan tilting operation is performed identically for other time periods, the detail description thereof is omitted.

Compared to a real time pan tilting performing method, the receive sensitivity based pan tilting performing method according to the present embodiment can reduce power consumption by reducing the number of calculating position information and the number of performing the pan tilting operation and also extend a life time of related product by delaying the deterioration of parts.

As an example of performing an auto pan tilting operation, a traveling distance and a traveling direction of an air vehicle at a time t0 are detected at a time t1, a future pan tilting angle is predicted by applying the detected traveling distance and direction of the time 0 to the time t1. That is, the pan tilting angle may be predicted through a history of previous pan tilting angles.

Since a distance between the air vehicle 110 and the relay unit 120 is about several tens km, the pan tilting operation is not performed as much as it is visually recognized.

The relay unit 120 must be aware of an accurate current location thereof in order to perform the pan tilting operation. It is because the relay unit 120 cannot perform the pan tilting operation although the air vehicle 110 transmits any GPS information to the relay unit 120 if there is a no reference point for the current location of the relay unit 120.

If the relay unit 120 is the stationary type, a coordinate of the fixed location of the relay unit 120 is stored in the PC 128 of the relay unit 120. If the relay unit 120 is the mobile type, a current location of the relay unit 120 can be obtained in real time by the GPS module 123 disposed in the relay unit 120. Although the relay unit 120 is the stationary type, the relay unit 120 may include the GPS module 123.

Communication between the air vehicle 110 and the relay unit 120 will be described, hereinafter.

At first, an initial value of GPS information between the air vehicle 110 and the relay unit 120 is set by a satellite 20 of FIG. 2. The relay unit 120 obtains current GPS information of the relay unit 120 through the GPS module 123 shown in FIG. 1. The GPS location of the air vehicle 110 is obtained by the GPS receiver 112.

After successfully establishing a WiMAX link between the relay unit 120 and the air vehicle 110, location difference between the air vehicle 110 and the relay unit 120 is automatically tracked in the PC 128.

Then, the auto pan tilting operation of the directional antennal 121 is performed by the pan tilting module 122 according to the movement of the air vehicle 110 as described above.

The photographing unit 111 of the air vehicle 110 operates and captures on-scene images, and the air vehicle 110 transmits the on-scene image information to the relay unit 120.

The relay unit 120 calculates a GPS location difference value between the air vehicle 110 and the relay unit 120 in real time. While calculating the GPS location difference value, the on-scene image information is continuously received and stored in the memory 126.

The on-scene image information and the GPS information thereof may be transmitted to a third area, for example, the external disaster prevention center 10.

For example, after the relay unit 120 receives the on-scene image information captured at a disaster area such as a scene of fire and the corresponding GPS information of the air vehicle 110, the on-scene image information and the corresponding GPS information may be transmitted to a first station, a hospital, a military base, and a regional government office in order to effectively dispatch and control rescuers and resources to the disaster area after determining an exact location and a current state of the disaster area in real time.

Although FIG. 1 shows that the air vehicle 110 includes one GPS receiver 112 and one omni antenna 113 and the relay unit 120 includes one direction antenna 121, one GPS module 123 and one pan tilting module 122, the present invention is not limited thereto.

For example, the air vehicle 110 may include a pair of omni antennas 113 and a pair of GPS receivers 112 corresponding to the pair of omni antennas 113. They may be independently used for the air vehicle 110 to photograph itself and the scene of the disaster at the same time or for the air vehicle 110 to photograph different images, separately. Here, the air vehicle 110 may include two photographing units 111.

Accordingly, the relay unit 120 may include two directional antenna 121, two GPS modules 123, and the two pan tilting modules 122 corresponding to the air vehicle 110 having the pair of omni antennas 113, GPS receivers 112, and photographing units 113.

Here, in order to further individually and accurately pan-tilt each of the directional antennas 121 disposed corresponding to each of the omni antennas, two GPS modules 123 are disposed corresponding to the pair of GPS receivers 112.

The air vehicle 110 may further include a small pan tilting device (not shown) in order to enable the relay unit 120 at the ground to automatically perform the pan-tilting operation of the two direction antennas 121 for accurately establishing a communication link.

While the present invention has been described with respect to the specific embodiments, it will be apparent to those skilled in the art that various changes and modifications may be made without departing from the spirit and scope of the invention as defined in the following claims.

1. A monitoring system using an air vehicle communicated based on a worldwide interoperability for microwave access (WiMAX) communication scheme, comprising:
an air vehicle including a photographing unit for capturing on-scene image information of a current flying area, and a global positioning system (GPS) receiver for receiving GPS information of the current flying area wherein the air vehicle transmits the on-scene image information and the GPS information, wirelessly; and
a relay unit for remotely controlling the air vehicle by receiving a travel command signal having information on a destination of the air vehicle, wirelessly transmitting the travel command signal to the air vehicle based on the WiMAX communication scheme, and wirelessly receiving the on-scene image information and the GPS information from the air vehicle based on the WiMAX communication scheme.

2. The monitoring system of claim 1, wherein the air vehicle uses an omni antenna to wirelessly transmit and receive information based on the WiMAX communication scheme, and
the relay unit uses a directional antenna to wirelessly transmit and receive information based on the WiMAX communication scheme.

3. The monitoring system of claim 2, wherein the relay unit further includes a pan tilting module for performing a pan tilting operation to control a direction of the directional antenna in real time using variation of GPS information of the air vehicle per a unit time, which is comparatively changed based on current location information of the relay unit.

4. The monitoring system of claim 3, wherein the pan tilting module control a direction of the directional antenna in real time using a pan angle variation (Δθ=θ−θ′) and a tilt angle variation (Δφ=φ−φ′), which are calculated based on a difference (ΔP=P−P′)between a before-flight coordinate P of the air vehicle before making flight and an after-flight coordinate P′ after making flight based on a coordinate O of the relay unit, and in case of the before-flight coordinate P of the air vehicle 110 before making flight, a pan angel θ and a tilt angle φ are defined as:
$$\begin{matrix}θ = {cos}^{- 1} ( \frac{z}{r} ) , r = \sqrt{{x}^{2} + {y}^{2} + {z}^{2}} \\ ϕ = {cos}^{- 1} ( \frac{x}{\sqrt{{x}^{2} + {y}^{2}}} ) ,\end{matrix}$$
wherein r denotes a distance from the coordinate O of the relay unit to the before-flight coordinate P of the air vehicle before making flight, and x, y, and z denote a x-axis coordinate (longitude), a y-axis coordinate (latitude), and z-axis coordinate (altitude) of the before-flight coordinate P of the air vehicle before making flight based on the coordinate O of the relay unit.

5. The monitoring system of claim 3, wherein the relay unit is a vehicle and further includes a GPS module receiving vehicle GPS information which is current location information of the vehicle, and
the pan tilting module controls a direction of the directional antenna in real time using variation of the GPS information value of the air vehicle per a unit time, which is comparatively changed based on the vehicle GPS information that is the current location information of the vehicle.

6. The monitoring system of claim 3, the relay unit performs an pan tilting operation when receive sensitivity of the on-scene image information and the GPS information transmitted from the air vehicle is dropped below a predetermined level.

7. The monitoring system of claim 1, wherein the relay unit further includes an additional relay unit for transmitting the received on-scene image information and the GPS information to an external disaster prevention center and for wirelessly relaying information between the relay unit and the external disaster prevention center based on the WiMAX communication scheme.

8. The monitoring system of claim 1, wherein the relay unit further includes a display unit for displaying the on-scene information and the GPS information corresponding to the on-scene information from the air vehicle with a map linked.

9. The monitoring system of claim 5, the relay unit performs an pan tilting operation when receive sensitivity of the on-scene image information and the GPS information transmitted from the air vehicle is dropped below a predetermined level.
